(19) United States
(12) Patent Application Publication
(10) Pub. No.: US 2022/0213754 A1
(43) Pub. Date: Jul. 7, 2022

(54) DOWNHOLE CERAMIC DISK RUPTURE BY LASER

(71) Applicant: Saudi Arabian Oil Company, Dhahran (SA)

(72) Inventors: Abdulrahman Al Ahmari, Juaymah (SA); Mohammed Al Dabbous, Qatif (SA)

(73) Assignee: Saudi Arabian Oil Company, Dhahran (SA)

(21) Appl. No.: 17/141,396

(22) Filed: Jan. 5, 2021

(51) Int. Cl. E21B 29/02; B23K 26/122; B23K 26/40

(52) U.S. Cl. CPC E21B 29/02; B23K 26/40; B23K 26/122

(57) ABSTRACT

Methods and systems are provided for breaching a ceramic disk installed in a wellbore during oil and gas well completion and production activities. More specifically, the disclosure relates to breaching a ceramic disk with a high-powered laser. The laser source is lowered into a wellbore, where a laser beam is used to heat the ceramic disk until the ceramic disk breaks or experiences structural failure. Logging information can be gathered by using the laser along with a receiver.

### FIELD

This disclosure relates to systems and methods for downhole tool removal. More specifically, this disclosure relates to removing functionality of a ceramic disk installed in a wellbore utilizing high powered lasers.

### BACKGROUND

During hydrocarbon well drilling and completion activities, production casing and production tubing is installed in a wellbore. Prior to production packer installation, ceramic disks are installed in the wellbore to maintain pressure and isolate the production tubing for wellbore operations. Once production packers are installed in the production casing, the ceramic disk is broken so that well flowback operations can begin.

Ceramic disks are generally ruptured with milling tools directed downhole with coiled tubing. Milling tools are drill-like tools that mechanically destroy the disk. Other ways of rupturing the ceramic disks include dropping go-devils or other tools in the wellbore. The conventional methods of milling or dropping tools results in the use of heavy equipment, takes substantial time and energy, and results in debris formation in the wellbore. The conventional methods of milling or dropping tools can also result in complications related to coil tubing getting locked-up (or stuck) within a wellbore, or breakage of heavy equipment. Additionally, it can take substantial time and energy to lower tools downhole, and other downhole operations may not be able to be performed downhole when the milling is being performed, or when the milling or other tools are lowered downhole. Due to the long tool transit time downhole and due to the risk of damage or lock-up from lowering and raising downhole tools through the wellbore, performing more than one tasks with the same tools or during a tool run is advantageous. Therefore, additional methods of rupturing ceramic disks downhole are desired, including methods performing multiple tasks with the same device.

### SUMMARY

The disclosure relates to systems and methods for removing the functionality of a ceramic disk installed in a wellbore during oil and gas well completion and production activities. The ceramic disks are installed in a wellbore during wellbore operations. The wellbore operations can include packer installation, wellbore isolation sub installation, logging operations, or other well completion or production activities. The ceramic disks can be installed in wellbore nipples, landing nipples, sealing sections of wellbore production piping, wellbore subs, or other sections of the production piping or casing of the wellbore, including screwing a threaded disk directly into producing piping or casing.

More specifically, the disclosure relates to breaching a ceramic disk with a high-powered laser that heats the ceramic disk until structural failure. Once breached, the ceramic disk can no longer hold pressure in the wellbore. Lasers can be used to heat materials, but have generally not been utilized in downhole operations for oil and gas production due to their sensitive operating nature being incompatible with the extreme operating conditions experienced downhole. Embodiments disclosed herein, however, utilize specialized industrial strength lasers that can withstand downhole conditions. These specialized industrial strength lasers can include external shielding given the extreme operating conditions encountered downhole. These lasers include hydrogen fluoride lasers, deuterium fluoride lasers; oxygen iodine lasers; carbon dioxide lasers; carbon monoxide lasers; free electron lasers; neodymium-doped yttrium aluminum garnet lasers; and krypton fluoride (excimer) lasers.

Therefore, disclosed is a method of breaching a ceramic disk installed in a wellbore, the ceramic disk operable to maintain pressure within the wellbore during a wellbore operation. The method includes the step of lowering a laser source into the wellbore, where the laser source is operable to generate a laser beam. The laser beam is operable to deliver thermal radiation to the ceramic disk when the laser beam is absorbed by the ceramic disk. The method also includes the step of heating the ceramic disk with the laser beam so that the ceramic disk is breached within the wellbore and can no longer maintain pressure within the wellbore.

In some embodiments, the laser source is operable to produce a high-powered laser beam. The laser beam has an infrared wavelength greater than 10,000 nm. The laser source provides greater than 500 W power when operated in a super pulsed mode. The laser source is operable to produce a blue light laser beam. The laser source is a CO2 laser.

In some embodiments, the method also includes the steps of determining a breakpoint temperature at which the ceramic disk breaches, and selecting the laser source so that the laser source is operable to generate the laser beam with sufficient thermal radiation to heat the ceramic disk to the breakpoint temperature. The step of determining the breakpoint temperature includes using an infrared thermometer to determine a penetration temperature for the ceramic disk.

In some embodiments, the method also includes the steps of directing the laser beam through a wellbore fluid to a receiver to generate a resulting laser beam; receiving the resulting laser beam with the receiver, and measuring properties of the resulting laser beam to determine characteristics of the wellbore and the wellbore fluid. The resulting laser beam has a wavelength between 800 and 1000 nanometers.

Further disclosed is a system for breaching the ceramic disk installed in the wellbore for the wellbore operation. The system includes the ceramic disk installed within the wellbore, where the ceramic disk is operable to maintain pressure during the wellbore operation. The system also includes the laser source which is operable to generate the laser beam and direct the laser beam onto the ceramic disk, and the laser beam, which is operable to transfer the thermal radiation to the ceramic disk such that the ceramic disk is heated to the point of fracture.

In some embodiments, the system also includes the receiver, which is operable to receive a resulting laser beam so that properties of the resulting laser beam can be used to determine characteristics of the wellbore and the wellbore fluid. The resulting laser beam is generated from the laser beam traveling through the wellbore fluid.

In some embodiments, the system also includes the filter, which is operable to generate a filtered laser beam when the laser beam is passed through the filter. The resulting laser beam is then generated from the filtered laser beam traveling through the wellbore fluid. The laser beam is a high-powered laser beam. The laser beam is a blue light laser. The laser source is a CO2 laser. The system can also include an insulation operable to preserve the thermal radiation of the system. The laser source can also include a neutral gas operable to increase the thermal radiation to the ceramic disk. The laser source is operable to produce the laser beam under a wellbore temperature and a wellbore pressure.

### BRIEF DESCRIPTION OF THE DRAWINGS

These and other features, aspects, and advantages of the present disclosure will become better understood with regard to the following descriptions, claims, and accompanying drawings. It is to be noted, however, that the drawings illustrate only several embodiments of the disclosure and are therefore not to be considered limiting of the scope as it can admit to other equally effective embodiments.

FIG. 1A is a schematic of a vertical wellbore laser system, according to an embodiment.

FIG. 1B is a schematic of a horizontal wellbore laser system, according to an embodiment.

FIG. 2A is a schematic of a logging laser beam system, according to an embodiment.

FIG. 2B is a schematic of a logging laser beam system with filter, according to an embodiment.

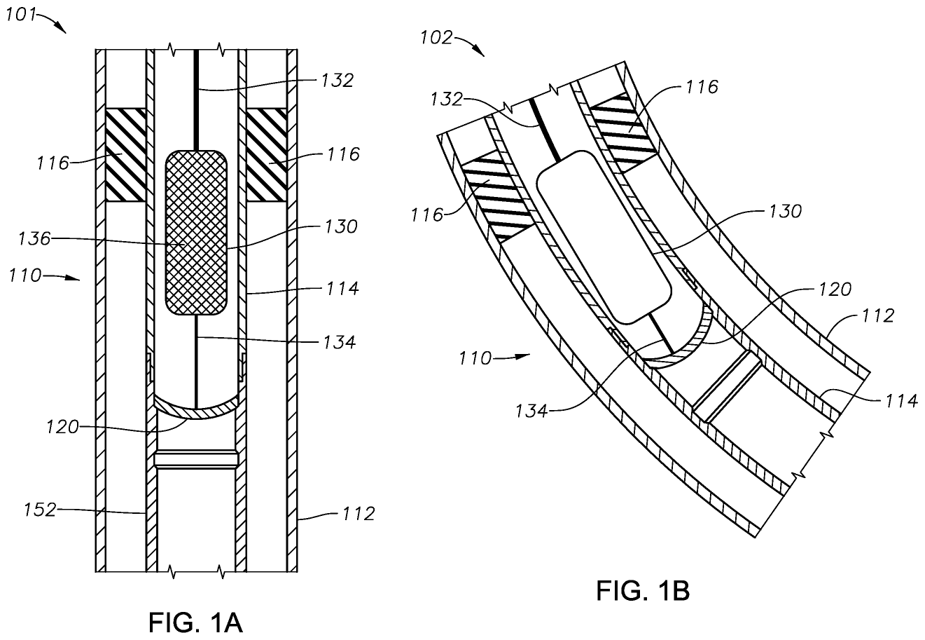

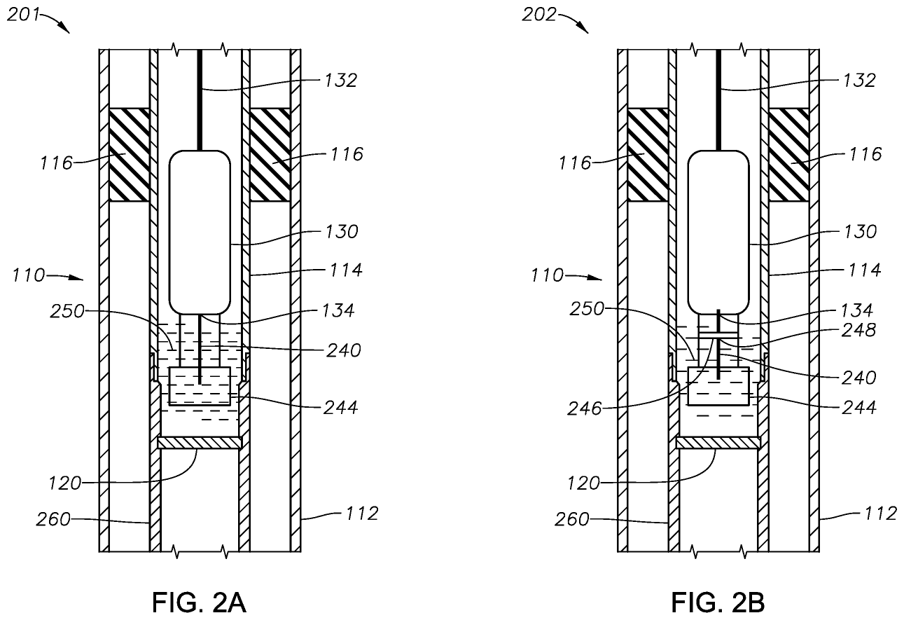

In the accompanying Figures, similar components or features, or both, can have a similar reference label. For the purpose of the simplified schematic illustrations and descriptions of FIGS. 1A through 2B, the numerous pumps, valves, temperature and pressure sensors, electronic controllers, and the like that can be employed and well known to those of ordinary skill in the art are not included. Further, accompanying components that are in conventional industrial operations are not depicted. However, operational components, such as those described in the present disclosure, can be added to the embodiments described in this disclosure.

### DETAILED DESCRIPTION

While the disclosure will be described with several embodiments, it is understood that one of ordinary skill in the relevant art will appreciate that many examples, variations and alterations to the systems and methods described are within the scope and spirit of the disclosure. Accordingly, the embodiments of the disclosure described are set forth without any loss of generality, and without imposing limitations, on the claims.

Advantages of the present disclosure include a non-contact physical breaking of the ceramic disk, potential long-distance intervention and breaking of the ceramic disk, and elimination of heavy downhole milling tools. Additionally, in some embodiments, the laser source can have dual functionality for logging purposes as well as disk rupturing, allowing for multiple actions downhole with one tool and one trip downhole. Logging advantageously allows data to be collected on the wellbore, the wellbore fluids, the formation, and other downhole conditions. Additionally, the embodiments disclosed herein can be deployed in oil and gas wellbores and with ceramic disks already known and used in the field—no special ceramic disk or wellbore operating techniques are required.

Referring to FIG. 1A, vertical wellbore laser system 101 is depicted. Wellbore 110 includes production casing 112 and production tubing 114. Installed in the annulus between production casing 112 and production tubing 114 are packers 116, installed during the wellbore operations. Installed within production tubing 114 is ceramic disk 120. Ceramic disk 120 can be any type of disk capable of maintaining pressure in production tubing 114 while the wellbore operation is being performed and capable of being heated to structural failure and breach, such as fracturing or rupturing. The wellbore operation can include the installation of packers 116. In some preferred embodiments, ceramic disk 120 is made of a ceramic material known in the art. The ceramic material can include any type of ceramic material known in the art suitable for downhole conditions. The ceramic material can include aluminum oxide, aluminum titanate, silicon carbide, silicon nitride, similar ceramic materials, or combinations of the same. Ceramic disk 120 is a flat, plate-like disk wedged or installed within production tubing 114; however, ceramic disk 120 can be any shape or size. Ceramic disk 120 is installed in nipple 152. In some embodiments, ceramic disk 120 is a semispherical shape or a convex/concave shape, where the convex side faces the higher of the pressures within the wellbore. Ceramic disk 120 can be installed by methods known in the art, including installation during production tubing installation. In some embodiments, ceramic disk 120 is installed in production tubing 114 at the surface.

Laser source 130 is deployed by lowering laser source 130 into production tubing 114. The lowering of laser source 130 can be performed by method known in the art, such as coiled tubing, slick line, wire line, or tractors. Downhole drones or other tools designed to deploy downhole tools from the surface can also be used to deploy laser source 130 into wellbore 110. Laser source 130 is lowered into wellbore 110 towards ceramic disk 120. The exact depth of ceramic disk 120 in wellbore 110 or the exact depth laser source 130 is lowered in wellbore 110 can be determined by methods known in the art, such as a casing collar locater. A casing collar locater is a downhole tool that can determine the depth downhole using a reference spot on the casing string, usually a magnetic anomaly measurement causing by the high molar mass of the casing string. In some embodiments, laser source 130 is lowered into wellbore 110 so that the distance between laser source 130 and ceramic disk 120 is less than about 500 feet, alternately less than about 400 feet, alternately less than about 300 feet, alternately less than about 250 feet, alternately less than about 200 feet, alternately less than about 150 feet, and alternately less than about 100 feet. In a preferred embodiment, laser source 130 is lowered so that a short distance less than 50 feet exists between laser source 130 and ceramic disk 120. Shorter distances between laser source 130 and ceramic disk 120 minimize the generation of plasma within wellbore 110. Laser source 130 is connected to laser source supply string 132 which can supply power and control mechanisms to laser source 130. Laser source 130 includes insulation 136 which can protect laser source 130 from the conditions of wellbore 110 including the wellbore temperature and the wellbore pressure, and to prevent the absorption of laser beam 134 inside wellbore 110. Insulation 136 can preserve energy and improve efficiency. Insulation 136 can include fiber glass materials or polyisocyanurate.

Laser source 130 can be any type of mechanism or apparatus capable of generating a laser beam. Laser source 130 is able to withstand the temperatures and pressures of typical wellbore conditions. Laser source 130 can withstand pressures up to 10,000 psi and temperatures of 320° F. Conventional lasers used until recently were too sensitive and could not withstand these typical wellbore conditions at or near ceramic disk 120. Recent advances in specialized laser technology, including blue laser technology, allow for industrial lasers to be able to withstand the conditions in a wellbore, including the wellbore pressure and the wellbore temperatures, which can be substantially higher than pressures and temperatures at the surface. Laser source 130 can be a high-powered laser that generates a high-powered laser beam. Laser source 130 can be a blue light laser, a carbon dioxide (CO2) laser, or a neutral gas laser. The CO2 laser can operate at a wavelength of 10.6 micrometer with an average power of 1 MW. The CO2 laser can be operated in either a continuous or a pulsed wave mode. In a continuous wave mode, the laser beam is continuously emitted. In a pulsed wave mode, the laser beam is not run continuously but generated in pulses. Laser source 130 can provide greater than 500 W power when operated in a super pulsed mode. While in super pulsed mode, lasers emit a frequency of radiations in the range of 20 to 100 W with vary high amplitudes over a short period of time, such as 250 nanoseconds. In a super pulsed mode the laser operates with a wavelength of approximately 900 nanometers. Advantageously, the super pulsed mode can have greater penetration due to the very high power and short time pulses, and requires less time to rupture the ceramic disk than a continuous wave mode. Additionally, the super pulsed mode results in a lower thermal emission, resulting in energy conservation, as compared to the continuous wave mode.

Laser source 130 can be a hydrogen fluoride laser with an operating wavelength in the range of 2.6 to 4.2 micrometers, or alternately a deuterium fluoride laser with an operating wavelength in the range of 2.6 to 4.2 micrometers. Laser source 130 can be a chemical oxygen iodine laser with an operating wavelength of about 1.315 micrometers. Advantageously, chemical oxygen iodine lasers have excellent precision and high range which can be useful in downhole applications. Laser source 130 can be a carbon monoxide laser with an operating wavelength in the range of 5 to 6 micrometers. Laser source 130 can be a free electron laser with an adjustable wavelength. Advantageously, the wavelength can be adjusted in case of reflection, blackbody radiation, or for other operational advantages. Laser source 130 can be a neodymium-doped yttrium aluminum garnet laser with an operating wavelength of about 1.06 micrometers and a power output of 4 kW. Laser source 130 can be a krypton fluoride excimer laser with an operating wavelength of about 0.248 micrometers and a power output of 10 kW. The krypton fluoride excimer laser can be operated in a repetitive pulsed laser mode. In a repetitive pulsed laser mode, the laser is not continuously emitted but is emitted in repeated pulses.

When activated, laser source 130 generates laser beam 134. Laser beam 134 is directed at ceramic disk 120. Laser beam 134 is a light beam that, when absorbed by ceramic disk 120 is converted to heat. Laser beam 134 delivers thermal radiation to ceramic disk 120 when laser beam 134 is absorbed by ceramic disk 120. Removal of debris within wellbore 110 can increase the effectiveness of laser beam 134. Laser beam 134 can be the high-powered laser beam. Laser beam 134 can have the infrared wavelength greater than 10,000 nm.

Laser beam 134 is directed at ceramic disk 120 for the amount of time so that sufficient thermal radiation can be transferred to ceramic disk 120, heating ceramic disk 120 leading to a structural failure of the ceramic material. The amount of time can be predetermined by lab tests, calculations based on the properties of the ceramic material and ceramic disk 120 and laser source 130, estimates based on previous applications, or the actual time required for laser beam 134 to sufficiently heat ceramic disk 120. Ceramic disk 120 is breached within wellbore 110 due to heating and other factors, such as wellbore pressures and compressive forces from the expansion of ceramic disk 120. In some embodiments, the amount of time laser beam 134 is directed at ceramic disk 120 is less than 60 minutes.

In some embodiments, the breakpoint temperature at which ceramic disk 120 ruptures can be determined in a laboratory setting. The breakpoint temperature is used herein to denote the temperature at which ceramic disk 120 ruptures or is expected to experience structural failure. The breakpoint temperature can be calculated, measured, estimated by laboratory testing, provided by the manufacturer, or established by other methods. The infrared thermometer can be used to determine the penetration temperature for ceramic disk 120 when factoring in the wellbore temperature and the wellbore pressure, as well as characteristics of ceramic disk 120. The penetration temperature is the temperature the surface of ceramic disk 120 must reach from the thermal radiation provided by laser beam 134 so that thermal radiation can penetrate to the center of ceramic disk 120 to reach the breakpoint temperature and lead to rupturing of ceramic disk 120. The amount of time needed for laser beam 134 to be directed at ceramic disk 120 can be estimated, calculated, or measured using the breakpoint temperature, the penetration temperature, and other factors as enumerated herein.

Referring to FIG. 1B, horizontal wellbore laser system 102 is depicted, and shares many of the same elements and characteristics of vertical wellbore laser system 101. Wellbore 110 is a horizontal wellbore. The methods disclosed herein can be applied for horizontal wellbore laser system 102. Due to the straight path of laser beam 134 and the non-linear path of wellbore 110, laser source 130 is positioned closer to ceramic disk 120 to prevent laser beam 134 from impacting production tubing 114, or to prevent production tubing 114 from intercepting laser beam 134, and to ensure laser beam 134 is focused on ceramic disk 120. In some embodiments, laser source 130 is lowered into wellbore 110 so that the distance between laser source 130 and ceramic disk 120 is less than about 50 feet, alternately less than about 40 feet, alternately less than about 30 feet, alternately less than about 20 feet, and alternately less than about 10 feet.

Referring to FIG. 2A, logging laser beam system 201 is depicted, and shares many of the same elements and characteristics as vertical wellbore laser system 101. Advantageously, logging laser beam system 201 has dual functionality as it can break a ceramic disk and can gather information on downhole conditions and wellbore fluid characteristics. Ceramic disk 120 is installed in disk sub 260. Ceramic disk 120 can be installed in wellbore 110 by any method. Logging laser beam system 201 also includes receiver 244 which can be attached to laser source 130 so that a distance exists between receiver 244 and laser source 130. Receiver 244 can be located one to five feet from laser source 130. During logging operations, laser beam 134 is directed through wellbore fluid 250, generating resulting laser beam 240. Wellbore fluid 250 can include production fluids, oil, gas, hydrocarbons, water, any other type of fluid found within an oil and gas wellbore, or combinations of the above.

Receiver 244 receives resulting laser beam 240. Resulting laser beam 240 can have a wavelength between 800 and 1000 nanometers. By measuring the amount of time it takes for resulting laser beam 240 to travel the distance from laser source 130 to receiver 244, velocities of laser beam 134 and resulting laser beam 240 through wellbore fluid 250 can be determined. The velocity of resulting laser beam 240 differs based on the medium and characteristics of wellbore fluid 250. By analyzing the velocity of resulting laser beam 240, characteristics of wellbore fluid 250 such as the water-cut and fluid composition can be determined. Characteristics of the surrounding rock can also be measured. Porosity as a function of time utilizing the Wyllie time-average equation can be calculated using Equation 1:

$$ϕ = \frac{Δ t - {t}_{ma}}{Δ {t}_{f} - Δ {t}_{ma}} , \qquad Eq . 1$$

In Eq. 1, Δt is the laser transit time in μsec/ft, Δt_{f} is the laser transit time through the fluid in μsec/ft, Δtₘₐ is the laser transit time through the rock matrix in μsec/ft, and ϕ is the total porosity of the rock. Δt_{f} and Δtₘₐ can be measuring and are constant for each medium. Receiver 244 can then transmit the information to the surface (not pictured), either by remote transmission or through laser source supply string 132 so that further analysis may be conducted.

Referring to FIG. 2B, logging laser beam system with filter 202 is depicted, and shares many of the same elements and characteristics as logging laser beam system 201. Logging laser beam system with filter 202 includes filter 246. Filter 246 can be any known mechanism through which certain wavelengths of light are blocked except for the desired wavelength that is measured. Laser beam 134 passes through filter 246 generating filtered laser beam 248. As filtered laser beam 248 travels through wellbore fluid 250, resulting laser beam 240 is generated. Receiver 244 receives resulting laser beam 240, and logging operations can be performed.

Although the present disclosure has been described in detail, it should be understood that various changes, substitutions, and alterations can be made without departing from the principle and scope of the disclosure. Accordingly, the scope of the present disclosure should be determined by the following claims and their appropriate legal equivalents.

Ranges may be expressed throughout as from about one particular value, or to about another particular value. When such a range is expressed, it is to be understood that another embodiment is from the one particular value or to the other particular value, along with all combinations within said range.

The singular forms “a,” “an,” and “the” include plural referents, unless the context clearly dictates otherwise.

As used in the specification and in the appended claims, the words “has,” and “include” and all grammatical variations thereof are each intended to have an open, non-limiting meaning that does not exclude additional elements or steps.

What is claimed is:

1. A method of breaching a ceramic disk installed in a wellbore operable to maintain pressure within the wellbore during a wellbore operation, the method comprising the steps of:
lowering a laser source into the wellbore, the laser source operable to generate a laser beam, the laser beam operable to deliver thermal radiation to the ceramic disk when the laser beam is absorbed by the ceramic disk; and
heating the ceramic disk with the laser beam such that the ceramic disk is breached within the wellbore and can no longer maintain pressure within the wellbore.

2. The method of claim 1, wherein the laser source is operable to produce a high-powered laser beam.

3. The method of claim 2, wherein the laser beam has an infrared wavelength greater than 10,000 nm.

4. The method of claim 2, wherein the laser source provides greater than 500 W power when operated in a super pulsed mode.

5. The method of claim 2, wherein the laser source is operable to produce a blue light laser beam.

6. The method of claim 2, where the laser source is a CO2 laser.

7. The method of claim 1, further comprising the steps of:
determining a breakpoint temperature at which the ceramic disk breaches; and
selecting the laser source such that the laser source is operable to generate the laser beam with sufficient thermal radiation to heat the ceramic disk to the breakpoint temperature.

8. The method of claim 7, wherein the step of determining a breakpoint temperature further comprises the step of using an infrared thermometer to determine a penetration temperature for the ceramic disk.

9. The method of claim 1, further comprising the steps of:
directing the laser beam through a wellbore fluid to a receiver to generate a resulting laser beam;
receiving the resulting laser beam with the receiver; and
measuring properties of the resulting laser beam to determine characteristics of the wellbore and the wellbore fluid.

10. The method of claim 9, wherein the resulting laser beam has a wavelength between 800 and 1000 nanometers.

11. A system for breaching a ceramic disk installed in a wellbore for a wellbore operation, the system comprising:
the ceramic disk installed within the wellbore, the ceramic disk operable to maintain pressure during the wellbore operation;
a laser source, the laser source operable to generate a laser beam and direct the laser beam onto the ceramic disk; and
the laser beam, operable to transfer a thermal radiation to the ceramic disk such that the ceramic disk is heated to a point of breach.

12. The system of claim 11, further comprising a receiver, the receiver operable to receive a resulting laser beam such that properties of the resulting laser beam can be used to determine characteristics of the wellbore and a wellbore fluid, wherein the resulting laser beam is generated from the laser beam traveling through the wellbore fluid.

13. The system of claim 12, further comprising a filter, the filter operable to generate a filtered laser beam when the laser beam is passed through the filter, wherein the resulting laser beam is generated from the filtered laser beam traveling through the wellbore fluid.

14. The system of claim 11, wherein the laser beam is a high-powered laser beam.

15. The system of claim 11, wherein the laser beam is a blue light laser.

16. The system of claim 11, wherein the laser source is a CO2 laser.

17. The system of claim 11, further comprising an insulation operable to preserve the thermal radiation of the system.

18. The system of claim 11, wherein the laser source further comprises a neutral gas operable to increase the thermal radiation to the ceramic disk.

19. The system of claim 11, wherein the laser source is operable to produce the laser beam under a wellbore temperature and a wellbore pressure.
